(19) United States
(12) Patent Application Publication
(10) Pub. No.: US 2017/0367544 A1
(43) Pub. Date: Dec. 28, 2017

(54) SUSPENDED TOWEL ASSEMBLY

(71) Applicant: Lloyd Gene. Zellmer, Carmel, CA (US)

(72) Inventor: Lloyd Gene. Zellmer, Carmel, CA (US)

(21) Appl. No.: 15/191,175

(22) Filed: Jun. 23, 2016

(51) Int. Cl. A47K 10/02; F16M 13/02; A47L 19/00

(52) U.S. Cl. CPC A47K 10/025; A47L 19/00; F16M 13/027

(57) ABSTRACT

Disclosed herein is a suspended towel assembly. The towel assembly is suspended from a structure convenient to a sink or a location where towels are commonly found. The towel assembly is suspended from a wall, a ceiling, a cabinet door or from any similar structure. The towel assembly includes an elastic cord having one end being anchored at the suspension structure. The other end of the elastic cord is connected to a towel. A connection member is used to create a secure connection between the towel and the elastic cord.

### BACKGROUND OF THE DISCLOSURE

### Field of the Invention

This invention relates generally to the field of domestic housewares. More particularly, this invention relates to an assembly for storing and using a towel in an area where towels can are commonly found.

### Background

In many areas of a home, one would commonly expect to find towels for a variety of useful purposes. For example, in a kitchen, one would expect to find towels near each sink. Towels are clearly useful for drying dishes, pots and pans and even drying one's hands.

Commonly, towels are left lying on the counter in a kitchen or put away in a drawer somewhere. When there are more than one in residence in a home, towels will be predictably missing or misplaced or taken to another unknown location. Countless number of hours are spent looking for missing towels, which add to the frustration and stress of daily living with others. When one's hands are wet, frenzy sometimes occurs in the search for the relief of a drying towel. Again, adding to the frustration and stress of modern living.

As any couple knows, living together can cause many stresses. Scurrying around attempting to find a towel to dry one's wet hands is an added stress that can be readily eliminated using the structure according to the disclosure herein.

In order to maintain a neat and orderly kitchen or any area where towels might be found, one would ordinarily put the towel in a location hidden from view. When, there are more than a single resident in a home, this can leave the remaining residents in search of the towel's hiding place. While the hiding the towel from view makes the kitchen or a similar location seem tidy, the functionality of having a towel in close proximity to the sink is negated. Again, these kinds of stresses can adversely affect a relationship and have deleterious effect on one's health.

What is needed is a simple, inexpensive and effective structure that would allow a kitchen or other similar area, to remain neat and tidy, while keeping the functionality of having a towel in close proximity and readily visible to all individuals in the household. Applicant herein has created an assembly which is easy to install, requiring no more than simple hand tools, and meets the needs of all of the parties in the household. It might even be thought of as a relationship saving device.

### SUMMARY OF THE DISCLOSURE

The assembly of the instant disclosure comprises a suspended towel assembly. The towel assembly is suspended from a structure convenient to a sink or a location where towels are commonly found. The towel assembly is suspended from a wall, a ceiling, a cabinet door or from any similar structure. The towel assembly includes an elastic cord having one end being anchored at the suspension structure. The other end of the elastic cord is connected to a towel. A connection member is used to create a secure connection between the towel and the elastic cord.

In accordance with the disclosure, the objects and advantages of the suspended towel assembly will be readily appreciated by those skilled in the art and those familiar with domestic relations in a family or roommate setting. Additionally, other objects and advantages will be understood and appreciated upon the use of the suspended towel assembly in accordance with this disclosure and upon a thorough reading of the disclosure herein.

In accordance with the above as will be further appreciated from a reading the description below, the suspended towel assembly comprises:

A suspended towel assembly, the assembly comprising:
a. a towel;
b. an elastic cord having a proximal end and a distal end;
c. an attachment member;
d. the towel being attached to the elastic cord at the distal end, the attachment member attaching the towel to the elastic cord; and
e. the elastic cord proximal end being anchored to a fixed and stable location.

In exemplary embodiment, the suspended towel assembly is suspended from an overhead cabinet door. In another exemplary embodiment, the suspended towel assembly is suspended from a lower cabinet door. In yet another exemplary embodiment, the elastic cord is hidden from view until the assembly is put into use.

In yet another exemplary embodiment, the suspended towel assembly includes a decorative member. The decorative member attaches at the connection point wherein the attachment member secures the towel to the elastic cord. Additionally, in yet another exemplary embodiment, a decorative member defines a tube-like member being ornamental as well as functional in nature and covering the substantial length of the elastic cord.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a perspective view of the suspended towel assembly, in accordance with this disclosure, suspended from various fixed and stable locations using an overhead cabinet anchoring.

FIG. 2 is a perspective view of the suspended towel assembly, in accordance with this disclosure, suspended from various fixed and stable locations using a lower cabinet anchoring.

FIG. 3 is a partial cross-section illustrating an overhead cabinet anchoring of the suspended towel assembly in accordance with this disclosure.

FIG. 4 is a perspective illustration of an attachment member firmly connecting the towel to the elastic member.

FIG. 5 illustrates alternative structures for preparing the suspended towel assembly in accordance with this disclosure for attachment of the decorative member.

FIG. 6 illustrates an exemplary decorative member covering the attachment point of the suspended towel assembly in accordance with this disclosure.

### DETAILED DESCRIPTION OF THE INVENTION

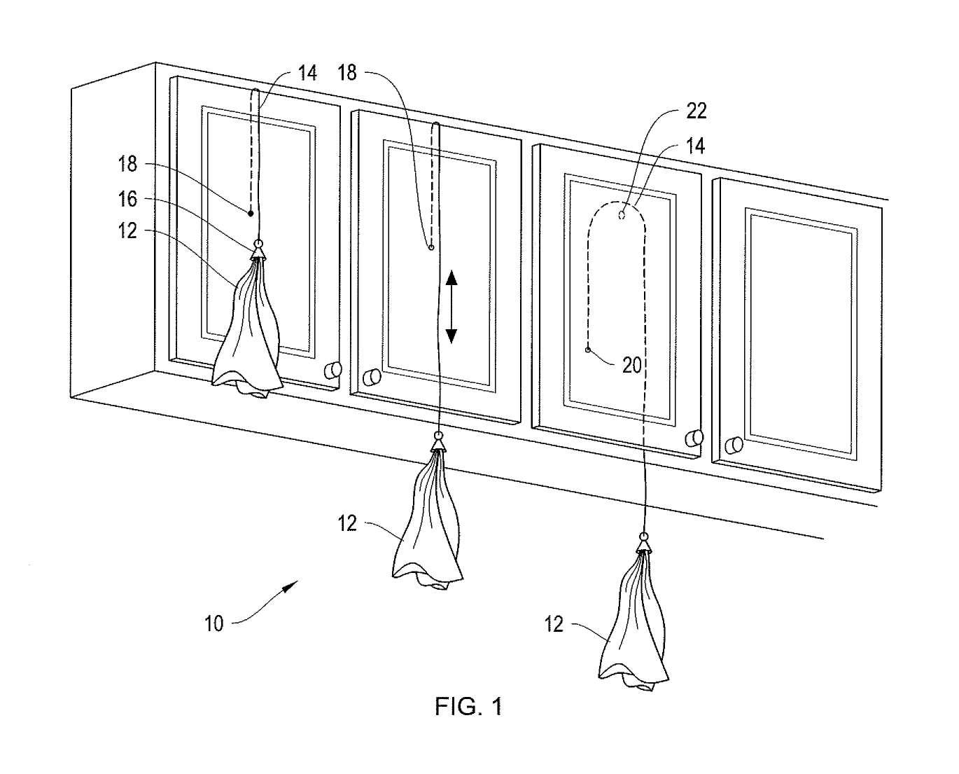

The disclosure herein will now be described with respect to FIG. 1, which illustrates an exemplary embodiment of the suspended towel assembly, shown generally by the numeral 10. In a first exemplary embodiment of the suspended towel assembly 10, the assembly 10 includes a towel 12, an elastic cord 14, and an attachment member 16. This first figure represents the assembly 10 in its normal unexpanded condition.

The elastic cord 14 has a proximal end and a distal end. As illustrated, the proximal end is anchored to the inside of an overhead cabinet door at anchor point 18, defining an overhead cabinet embodiment. Also, as illustrated, the distal end of the elastic cord 14 is connected to the towel 12. In this illustration, the assembly 10 is tucked away neatly and is easily found upon a desire to use the towel.

The next illustration shows the assembly 10 in its expanded condition ready for use. During use, the user pulls the towel 12, thereby expanding the elastic cord 14, so that the user can bring the towel into close proximity with the objects of usage. This allows the user to dry dishes, utensils, his/her hands and the like. Once the user completes his/her task, the towel 12 is released allowing it to return to its original and normal unexpanded condition in the earlier described illustration.

A second exemplary embodiment is also illustrated in FIG. 1. In this second exemplary embodiment, the suspended towel assembly 10 is shown having the elastic cord 14 hidden from view until the assembly 10 is in use. In this exemplary embodiment, the elastic cord 14 has an anchoring point 20 of the lower portion of the inside cabinet panel of the overhead cabinet. Additionally, a pivot point 22 is provided above the anchoring point 20. By looping the elastic cord 14 around the pivot point 22, the elastic cord 14 remains hidden from view until the towel 12 is put into use.

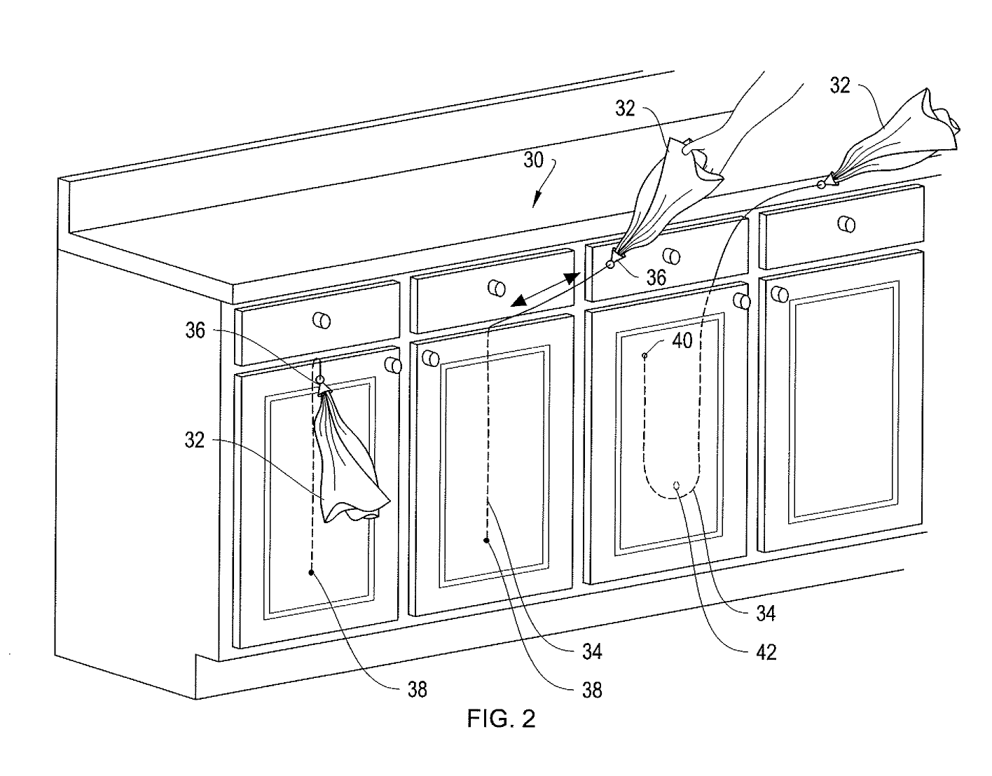

The disclosure herein will now be described with respect to FIG. 2, which illustrates a lower cabinet exemplary embodiment of the suspended towel assembly, shown generally by the numeral 30. In a first exemplary embodiment of the suspended towel assembly 10, the assembly 10 includes a towel 12, an elastic cord 14, and an attachment member 16. With respect to FIG. 2, the elements are the same but given different reference numerals to assist the understanding of the disclosure herein. In FIG. 2, the suspended towel assembly 30, the assembly 30 includes a towel 32, an elastic cord 34, and an attachment member 36. This first described figure of the lower cabinet embodiment represents the assembly 30 in its normal unexpanded condition.

The elastic cord 34 has a proximal end and a distal end. As illustrated, the proximal end is anchored to the inside of an overhead cabinet door at anchor point 38, defining a lower cabinet embodiment. Also, as illustrated, the distal end of the elastic cord 34 is connected to the towel 32. In this illustration, the assembly 30 is tucked away neatly and is easily found upon a desire to use the towel.

The next illustration shows the assembly 30 in its expanded condition ready for use. During use, the user pulls the towel 32, thereby expanding the elastic cord 34, so that the user can bring the towel into close proximity with the objects of usage. This allows the user to dry dishes, utensils, his/her hands and the like. Once the user completes his/her task, the towel 32 is released allowing it to return to its original and normal unexpanded condition in the earlier described illustration.

A second exemplary embodiment of the lower cabinet embodiment 30 is also illustrated in FIG. 2. In this second exemplary embodiment, the suspended towel assembly 30 is shown having the elastic cord 34 hidden from view until the assembly 30 is in use. In this exemplary embodiment, the elastic cord 34 has an anchoring 40 of the lower portion of the inside cabinet panel of the overhead cabinet. Additionally, a pivot point 42 is provided above the anchoring point 40. By looping the elastic cord 34 around the pivot point, the elastic cord 34 remains hidden from view until the towel 32 is put into use.

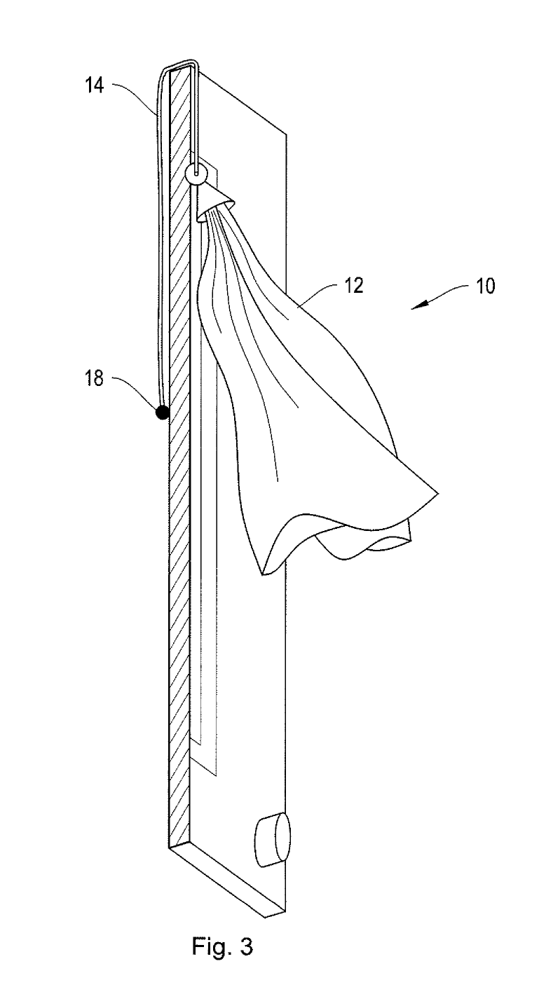

With respect to FIG. 3, there is shown the overhead cabinet embodiment suspended towel assembly 10 in partial cross-section. As illustrated clearly, the suspended towel assembly 10 includes an anchor point 18 on the inside panel of the overhead cabinet. The elastic cord 14 is the open the door of the cabinet as shown. At the distal end of the elastic cord 14, the towel 12 is attached thereto.

Additional embodiments of the suspended towel assembly are within the contemplation of the invention herein. For example, while not shown, the anchoring point of the suspended towel assembly in an exemplary embodiment is the ceiling of the rooms in which it is desired to use the suspended towel assembly. In fact, there is virtually no limitation to where the anchoring point exists. As long as the assembly remains anchored and suspended, it is believed to be within the scope of the disclosure herein.

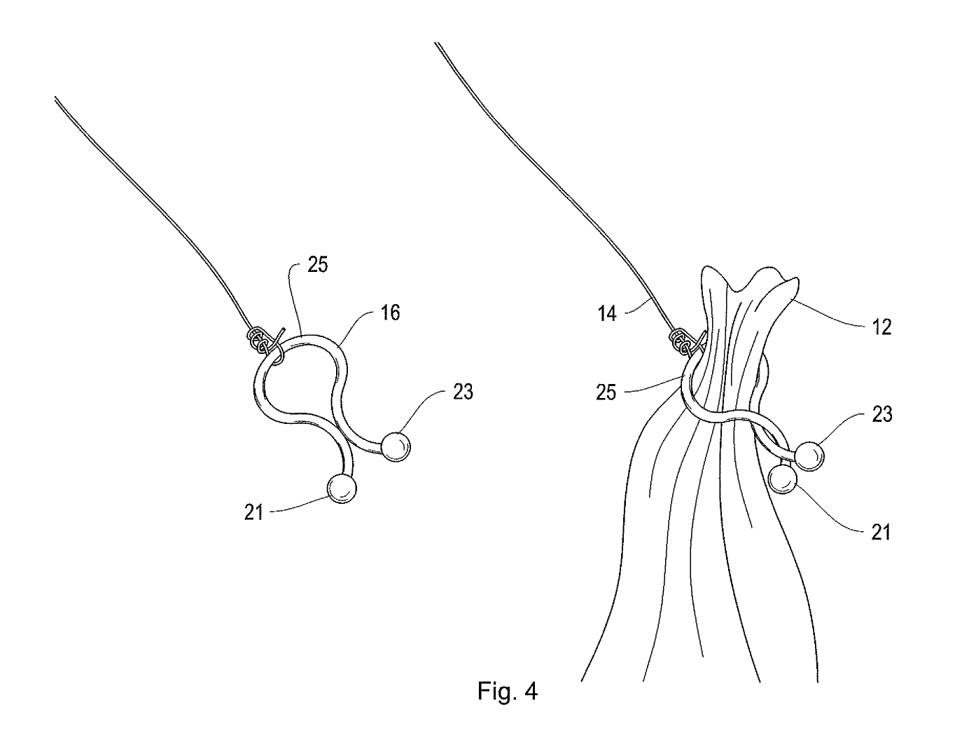

With particular reference to FIG. 4, there is shown an enlarged view of the attachment member 16 being attached to the towel 12. In the exemplary embodiment of the attachment member 16 illustrated in FIG. 4, the attachment member 16 defines a common electrical clip for tying bundles of cables together. This type of claim is commonly found in hardware stores across the United States and other places. The clip includes a first end 21 and a second end 23. A middle portion 25 is circular and attaches between the two ends 21 and 23. A simple knot connects the attachment member 16 to the elastic cord 14. One end of the towel 12 is pulled through the circular middle portion 25. When a sufficient amount of the towel 12 is pulled through the clip, the ends 21 and 23 are intertwined, clamping the towel end within the attachment member 16 for secure connection thereto.

It will, of course, be appreciated that within the spirit and scope of the disclosure herein, other structures may be used for creating a secure connection between the towel 12 and the elastic member 14. In no way, is it intended that the description of the electrical clip herein be considered as the exclusive means for creating the secure connection.

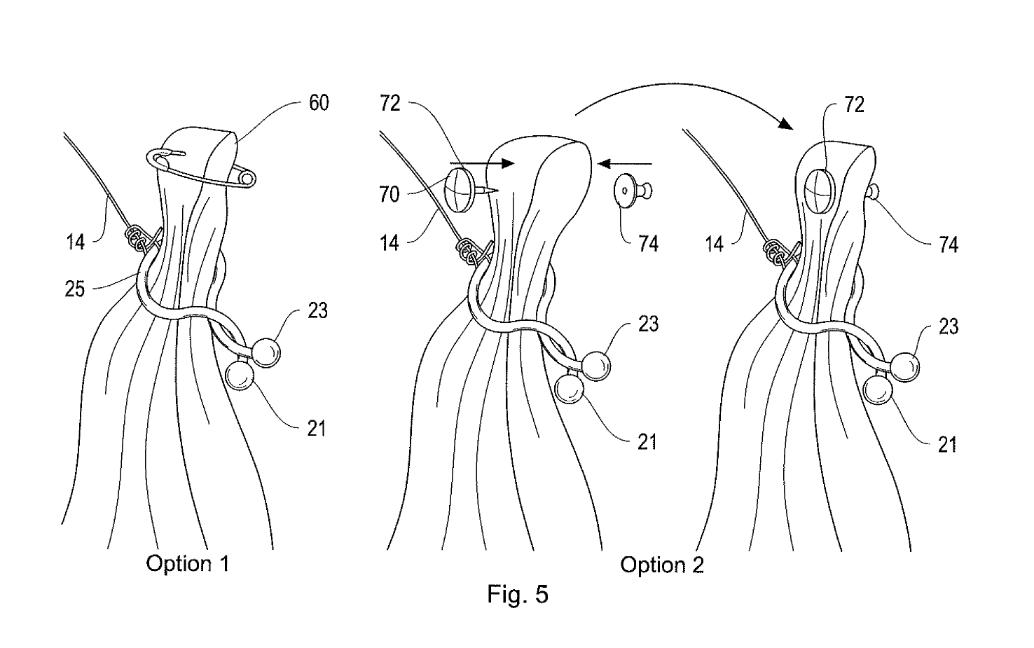

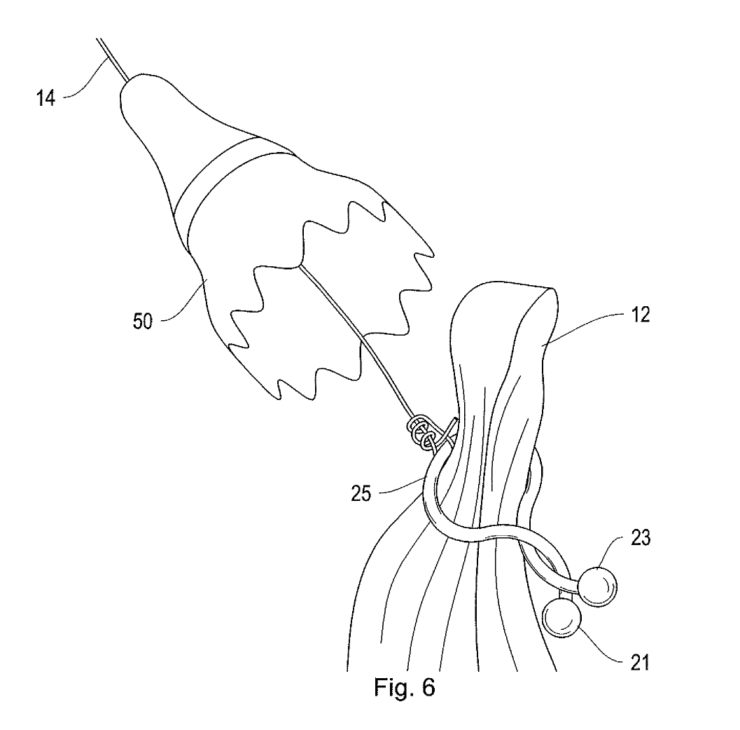

With particular reference to FIG. 5, there is shown to options for preparing the suspended towel assembly for attachment of a decorative member 50 (not shown in FIG. 5, but shown in FIG. 6). In the preparation of the attachment of decorative member 50 to the end of the towel 12, the end of the towel 12 is tied off in a neat and compact bundle. Under Option 1, a safety pin 60 is pushed through the end of towel 12. Once the safety pin is closed, the desired result of a neat and compact bundle is achieved as clearly illustrated in FIG. 5.

Under Option 2, a push pin 70 is provided as illustrated in FIG. 5. The push pin 70 has a male member 72 and a female member 74. The male member 72 is inserted through the end of the towel 12 and is then received by the female member 74. As with the earlier described option, the end of the towel 12 forms a neat and compact bundle in preparation of the attachment of decorative member 50.

As shown in FIG. 6, once the end of the towel 12 has been prepared for connection with the decorative member 50, the decorative member 50 is slid over the end of the towel 12 until a secure force fit is achieved. In the exemplary embodiment shown in FIG. 6, the decorative member resembles a hat on a birthday cake. It will be appreciated that within the spirit and scope of the invention, other decorative members may be chosen in various exemplary embodiments. By describing one particular decorative member, there is no intention to limit the scope of the invention to the exclusive use of such a decorative member.

Additionally within the spirit and scope of the invention, the elastic court 14 made similarly be covered with a decorative member. Although not shown, it is contemplated that a tube-like member having a pleasant and decorative style may be slid over the elastic member 14 to provide a decorative effect without interfering with the functionality of the elastic member 14.

It will be noted that the various features and elements and functionality of FIGS. 3-6 have been described with regard to one exemplary embodiment, namely suspended towel assembly 10. It will be appreciated that other exemplary embodiments, including suspended towel assembly 30 are similarly adapted and produce the same functionality features and elements found in FIGS. 3-6.

While the foregoing detailed description has described, in detail, several embodiments of the suspended tell assembly in accordance with the invention herein, it will be appreciated that these embodiments are not limiting of the invention. In fact, there are virtually and infinite number of embodiments that are not mentioned could easily be within the scope and spirit of this invention. Thus, the invention is to be limited only by the claims as set forth below.

1. A suspended towel assembly, the assembly comprising: a towel; an elastic cord having a proximal end and a distal end; an attachment member;
the towel being attached to elastic cord at the distal end, the attachment member attaching the towel to the elastic cord; and
the elastic cord proximal end being anchored to a fixed and stable location.

2. The suspended towel assembly as set forth in claim 1, wherein the fixed and stable location defines the inside of a cabinet door.

3. The suspended towel assembly as set forth in claim 2, wherein the cabinet door has an inside panel and the panel has a top, middle and bottom defining a fixed and stable locations the inside of a cabinet door.

4. The suspended towel assembly as set forth in claim 3, wherein the towel assembly is affixed to the top of the inside of a cabinet door.

5. The suspended towel assembly as set forth in claim 3, wherein the towel assembly is affixed to the middle of the inside of a cabinet door.

6. The suspended towel assembly as set forth in claim 3, wherein the towel assembly is affixed to the bottom of the inside of a cabinet door.

7. The suspended towel assembly as set forth in claim 3, wherein the elastic cord is substantially hidden from view during usage of the towel assembly.

8. The suspended towel assembly as set forth in claim 2, wherein the towel assembly is affixed to the top of the inside of the cabinet door, which is located overhead.

9. The suspended towel assembly as set forth in claim 1, wherein the fixed and stable location defines a ceiling.

10. The suspended towel assembly as set forth in claim 1, wherein the fixed and stable location defines a wall.

11. The suspended towel assembly as set forth in claim 2, wherein the attachment member defines an electrical clip.

12. The suspended towel assembly as set forth in claim 2, wherein the attachment member is covered by a decorative member.

13. The suspended towel assembly as set forth in claim 11, wherein the electrical clip is covered by a decorative member.

14. The suspended towel assembly as set forth in claim 7, wherein the elastic cord is anchored at one end to the fixed and stable location and wherein the elastic cord is looped around a pivot point so the cord remains hidden from view except in use, when the elastic cord is expanded.

15. A suspended towel assembly, the assembly including a towel and comprising:
an elastic cord having a proximal end and a distal end;
an attachment member;
the towel being attached to elastic cord at the distal end, the attachment member attaching the towel to the elastic cord; and
the elastic cord proximal end being anchored to a fixed and stable location.

16. A suspended towel assembly, the assembly comprising:
an elastic cord having a proximal end and a distal end, the elastic cord, at the distal end, being adapted for connection with a towel;
an attachment member being adapted for attaching the towel to the elastic cord; and
the elastic cord proximal end being anchored to a fixed and stable location.
